(19) United States
(12) Patent Application Publication
(10) Pub. No.: US 2025/0241824 A1
(43) Pub. Date: Jul. 31, 2025

(54) CHILD-PROOF STICK PACK

(71) Applicant: BAYER HEALTHCARE LLC, Whippany, NJ (US)

(72) Inventor: Jeffrey TOWNSEND, Whippany, NJ (US)

(21) Appl. No.: 18/848,564

(22) PCT Filed: Mar. 22, 2023
(86) PCT No.: PCT/US2023/015959

§ 371 Date: Sep. 19, 2024

Related U.S. Application Data
(60) Provisional application No. 63/322,993, filed on Mar. 23, 2022.
(60) Provisional application No. 63/432,900, filed on Dec. 15, 2022.

(51) Int. Cl. A61J 1/14; B65D 75/58

(52) U.S. Cl. CPC A61J 1/14; B65D 75/5805; B65D 2215/04

(57) ABSTRACT

Provided are child-proof stick packs comprising: a single sheet of film comprising two or more layers, wherein at least one layer comprises polyethylene terephthalate and faces an environment exterior to the stick pack; a laser-scored design on the film comprising a plurality of scores, wherein each score of the plurality of scores comprises an area in which the polyethylene terephthalate layer is weakened or removed from the film, wherein the stick pack comprises a bottom seal, a top seal, and a rear seal extending between the top seal and the bottom seal, is configured to contain one or more of an active pharmaceutical ingredient, therapeutic agent, or supplement and cannot be opened by more than 20% of children under the age of 5 years using only two hands.

### CROSS-REFERENCE TO RELATED APPLICATIONS

This application claims priority to and benefit of U.S. Provisional Patent Application No. 63/322,993, filed Mar. 23, 2022, and U.S. Provisional Patent Application No. 63/432,900, filed Dec. 15, 2022, each of which is incorporated herein by reference in its entirety.

### FIELD

The present disclosure generally relates to stick packs, and more particularly, to stick packs that can prevent children from opening and accessing the contents of the stick pack.

### BACKGROUND

Stick packs are flexible packages designed to contain a single serve dosage. Common materials that are packaged using stick packs include drink mixes (e.g., vitamin mixes, coffee, tea), nutritional supplements (e.g., protein powder, collagen), cosmetics, and spices and sweeteners. Stick packs are particularly useful for on-the-go applications and eliminate the need for a user to manually measure a single dose or serving.

Often, stick packs are used for powders materials, but can also be used for gels and liquids. The stick pack includes a perforation and/or small tear along an edge of the packaging to enable a user to easily tear open the stick pack and access its contents.

### SUMMARY

Provided herein are child-proof stick packs. Child-proof stick packs are particularly applicable for single dosage materials involving potential harmful substances. For example, therapeutic agents and/or active pharmaceutical ingredients (APIs) can be harmful in the hands of children. Thus, it is necessary, if a therapeutic agent and/or API is packaged using a stick pack, that the stick pack resist opening by a child. However, the stick pack is, at the same time, relatively easy to open by an adult. Accordingly, the stick packs provided herein are laser-scored. It has been determined that laser scoring a particular patterns onto the stick pack sufficiently weakens the outer layer of the stick pack to allow an adult to easily open the stick pack, while at the same time meeting child resistant criteria.

The stick packs described herein may include any of various laser scoring designs, described in detail below. Each of the laser scoring designs allows an adult to rip open the stick pack using just fingers and a thumb and without requiring the use of scissors. However, the stick pack film and the laser scoring patterns of the stick packs provided withstand the same tearing action when performed by a child, such that the stick packs cannot be easily opened by a child.

The film used for the stick packs include several layers. The film can include layers of polyolefin (e.g., polyethylenes, polypropylenes, copolymers of ethylene and acrylic acid, polyethylene terephthalate (PET)) and aluminum. In some embodiments, the film includes material layers in the following order: a first layer of polyolefin (that, when the stick pack is assembled and filled, is in direct contact with the fill contents), a first layer of aluminum, a second layer of polyolefin, and a first layer of PET (that, when the stick pack is assembled and filled, faces an exterior environment). In some embodiments, the laser scoring process only weakens or defeats the outer (second) PET layer, and the remaining layers of the film stay intact.

In some embodiments, provided is a child-proof stick pack comprising: a single sheet of film comprising two or more layers, wherein at least one layer comprises polyethylene terephthalate and faces an environment exterior to the stick pack; a laser-scored design on the film comprising a plurality of scores, wherein each score of the plurality of scores comprises an area in which the polyethylene terephthalate layer is weakened or removed from the film, wherein the stick pack comprises a bottom seal, a top seal, and a rear seal extending between the top seal and the bottom seal, is configured to contain one or more of an active pharmaceutical ingredient, therapeutic agent, or supplement and cannot be opened by more than 20% of children under the age of 5 years using only two hands.

In some embodiments of the child-proof stick pack, the stick pack cannot be opened by more than 15% of children under the age of 5 years using only two hands.

In some embodiments of the child-proof stick pack, the stick pack cannot be opened by more than 10% of children under the age of 5 years using only two hands.

In some embodiments of the child-proof stick pack, the plurality of scores extend horizontally across a width of the stick pack and perpendicular to the extending direction of the rear seal.

In some embodiments of the child-proof stick pack, the plurality of scores are located closer to the top seal of the stick pack than the bottom seal.

In some embodiments of the child-proof stick pack, the film comprises a first layer of polyethylene.

In some embodiments of the child-proof stick pack, the film comprises a layer of aluminum overlying the layer of polyethylene.

In some embodiments of the child-proof stick pack, the film comprises a second layer of polyethylene overlying the layer of aluminum.

In some embodiments of the child-proof stick pack, the layer of polyethylene terephthalate overlies the second layer of polyethylene.

In some embodiments of the child-proof stick pack, the laser-scored design comprises two rows of scores.

In some embodiments of the child-proof stick pack, the laser-scored design comprises three rows of scores.

In some embodiments of the child-proof stick pack, each score is 0.5-0.7 mm wide.

In some embodiments of the child-proof stick pack, each score is 0.3-0.6 mm in height.

In some embodiments of the child-proof stick pack, a vertical distance between any two rows of scores is 0.6-0.9 mm, as measure from a bottom edge of a score of a first row to a location horizontally aligned with a top edge of a score of a second row, wherein the second row is below the first row.

In some embodiments of the child-proof stick pack, an edge of the single sheet of film is not scored.

In some embodiments of the child-proof stick pack, an edge of the single sheet of film is scored.

In some embodiments of the child-proof stick pack, the scores of a first row are not vertically aligned with the scores of a second row.

In some embodiments of the child-proof stick pack, at least one score of a first row is vertically aligned with at least one score of a second row.

In some embodiments of the child-proof stick pack, the first layer of polyethylene is 20-40 microns thick.

In some embodiments of the child-proof stick pack, the layer of aluminum is 20-30 microns thick.

In some embodiments of the child-proof stick pack, the second layer of polyethylene is 5-30 microns thick.

In some embodiments of the child-proof stick pack, the layer of polyethylene terephthalate is 15-25 microns thick.

In some embodiments of the child-proof stick pack, the one or more of an active pharmaceutical ingredient, therapeutic agent, or supplement comprises a non-steroidal anti-inflammatory drug.

In some embodiments of the child-proof stick pack, the non-steroidal anti-inflammatory drug comprises one or more of naproxen sodium, acetylsalicylic acid, acetaminophen, or ibuprofen.

In some embodiments of the child-proof stick pack, the one or more of an active pharmaceutical ingredient, therapeutic agent, or supplement comprises an antihistamine.

In some embodiments of the child-proof stick pack, the antihistamine comprises one or more of loratadine, desloratadine, diphenylhydramine, pseudoephedrine sulfate, or phenylephrine hydrochloride.

In some embodiments of the child-proof stick pack, the one or more of an active pharmaceutical ingredient, therapeutic agent, or supplement comprises one or more of omeprazole, esomeprazole magnesium, sodium bicarbonate, polyethylene glycol 3350, caffeine, multivitamins, teas, protein powder, orlistat, doconazole, nizatidine, levonorgestrel, sildenafil citrate, or vardenafil.

In some embodiments, provided is a child-proof stick pack comprising: a single sheet of film comprising two or more layers, wherein at least one layer comprises polyethylene terephthalate and faces an environment exterior to the stick pack; a laser-scored design on the film comprising a plurality of scores, wherein each score of the plurality of scores comprises an area in which the polyethylene terephthalate layer is weakened or removed from the film, wherein the stick pack comprises a bottom seal, a top seal, and a rear seal extending between the top seal and the bottom seal, and cannot be opened by more than 20% of children under the age of 5 years using only two hands; and wherein the child-proof stick pack encloses a fill formulation comprising one or more of aspirin or caffeine.

In some embodiments, any one or more of the features, characteristics, or elements discussed above with respect to any of the embodiments may be incorporated into any of the other embodiments mentioned above or described elsewhere herein.

### BRIEF DESCRIPTION OF THE FIGURES

FIG. 1 shows a front (left) and back (right) view of a stick pack, according to some embodiments;

FIG. 2A shows a cross-sectional view of a microscopic image of a laser-scored film, according to some embodiments;

FIG. 2B shows a top view of a microscopic image of a laser-scored film, according to some embodiments;

FIG. 3 shows various laser-scoring designs, according to some embodiments;

FIG. 4A shows various laser-scoring designs, according to some embodiments;

FIG. 4B shows various laser-scoring designs, according to some embodiments;

FIG. 5 shows two specific laser-scoring designs, Gr2 and Mr3, according to some embodiments;

FIG. 6 shows a film design comprising the Gr2 laser-scoring design, according to some embodiments;

FIG. 7A shows a microscopic image of a Gr2 scoring design, according to some embodiments;

FIG. 7B shows a microscopic image of a Gr2 scoring design, according to some embodiments;

FIG. 8 shows a film design comprising the Mr3 laser-scoring design, according to some embodiments;

FIG. 9A shows a microscopic image of an Mr3 scoring design, according to some embodiments;

FIG. 9B shows a microscopic image of an Mr3 scoring design, according to some embodiments;

FIG. 9C shows a microscopic image of an Mr3 scoring design, according to some embodiments;

FIG. 10A shows a film design comprising a laser-scoring design that does not score the edge of the film, according to some embodiments;

FIG. 10B shows a film design comprising a laser-scoring design that does not score the edge of the film, according to some embodiments;

FIG. 11A provides visual instructions for opening stick pack having an Ar1 laser-scoring design;

FIG. 11B provides visual instructions for opening stick pack having an Er2 laser-scoring design;

FIG. 11C provides visual instructions for opening stick pack having an Gr2 laser-scoring design; and

FIG. 11D provides visual instructions for opening stick pack having an Mr3 laser-scoring design.

### DETAILED DESCRIPTION

Described herein are child-resistant stick packs that are designed to contain single dosages of drink mixes, cosmetics, spices, sweeteners, nutritional supplements, and the like. In some cases, the fill contents of a stick pack may comprise substances that, in the presence of children, can be unsafe. For example, many therapeutic agents and/or active pharmaceutical ingredients can be dangerous to children, particularly when handled unsupervised. Accordingly, the stick packs discussed herein are designed to resist tampering from children while at the same time still being relatively easy for adults to open. Because stick packs are often designed for users to use on-the-go (since they usually contain a single dosage of fill content), it is particularly desirable for the stick pack to be able to be opened by a user without the use of scissors.

It has been determined that laser scoring the stick pack film sufficiently comprises the film to allow an adult user to adequately and easily tear open the stick pack by only using their fingers and thumb(s), while at the same time maintaining sufficient integrity of the stick pack film such that it does not give way to a child trying to tear it open. Specifically, the laser scoring methods used herein damage or weaken just the outer layer of the film, in some embodiments. The remaining layers of the film can remain intact.

Described below are various laser-scoring designs. Whether the stick pack can be easily opened by an adult, yet resist child tampering at the same time, is dependent on the laser-scoring design. In some embodiments, a given laser-score design may be appropriate for one stick pack application (including fill contents) but not for another stick pack application. In some embodiments, the stick packs described herein meet the requirements for child-proof packaging set forth in 16 CFR Part 1700 of the Poison Prevention Packaging Act of 1970.

Referring now to the drawings, like parts are marked throughout the specification and drawings with the same reference numerals, respectively.

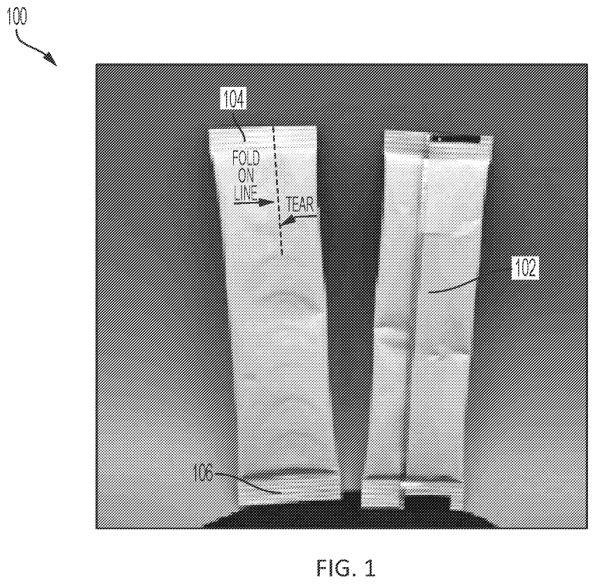

FIG. 1 shows a front (left) and back (right) view of a stick pack 100, according to some embodiments. As shown, the stick pack of FIG. 1 includes a single sheet of film sealed in three locations to form an enclosed package; The film sheet is sealed shut at the back (right) of the stick pack to form a rear seam 102. Rear seam 102 forms a cylindrical shape, and then the top and bottom seals (104 and 106, respectively), form an enclosed stick pack.

In some embodiments, a stick pack described herein includes a therapeutic agent and/or an active pharmaceutical ingredient. For example, suitable therapeutic agent and/or an active pharmaceutical ingredients can include, but are not limited to, NSAIDS/analgesics such as naproxen sodium, acetylsalicylic acid, acetaminophen, diclofenac, ketorolac, meloxicam, and/or ibuprofen; antihistamines such as loratadine, desloratadine, diphenylhydramine, pseudoephedrine sulfate, levocetirizine, promethazine, cetirizine, fexofenadine, chlorpheniramine, fexofenadine, carbinoxamine, and/or phenylephrine hydrochloride, or other therapeutic agents/active pharmaceutical ingredients/substances such as omeprazole, esomeprazole magnesium, sodium bicarbonate, polyethylene glycol 3350, caffeine, multivitamins, teas, protein powder, orlistat, doconazole, nizatidine, levonorgestrel, sildenafil citrate, and/or vardenafil.

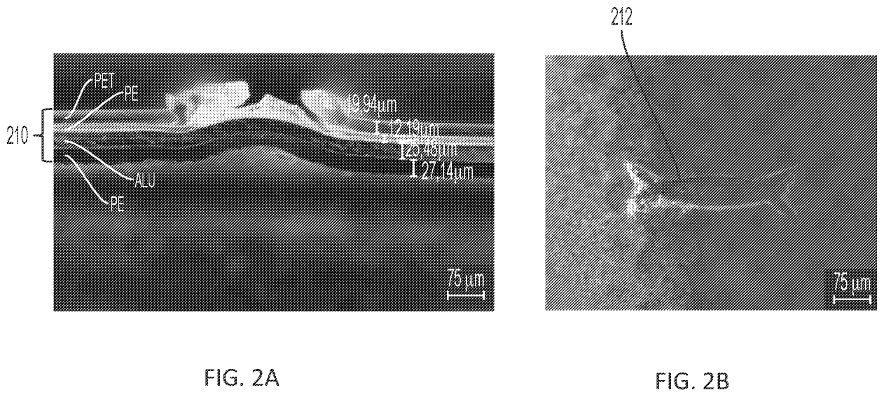

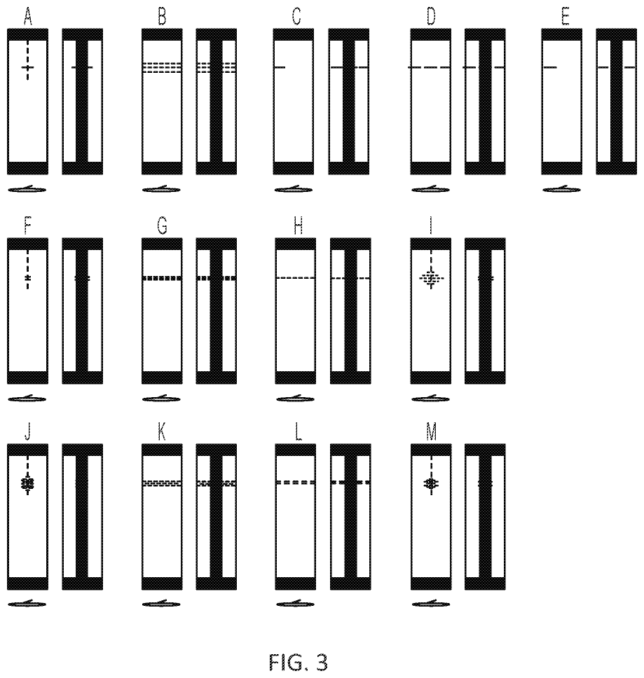

FIG. 2A shows a cross-sectional view of a microscopic image of a laser-scored film 210, according to some embodiments. As shown, the film 210 includes four layers. In some embodiments, film 210 may include 2, 3, 4, 5, 6, 7, or 8 layers. In some embodiments, film 210 may comprise one or more polymer layers. Suitable polymeric materials may include polyolefins such as polyethylene, polypropylene, polyethylene terephthalate, and/or copolymers including ethylene and acrylic acid. In some embodiments, film 210 may comprise one or more layers comprising a metal. Suitable metallic layers can include aluminum.

Film 210 comprises a first layer. In some embodiments, the first layer is in contact with the fill contents of the stick pack when the film is used to form a stick pack. In some embodiments, the first layer comprises a polymeric material. In some embodiments, the first layer comprises polyethylene. The first layer may have a thickness of 10-100, 10-50, 20-40, or 25-30 microns. In some embodiments, the first layer may have a thickness of less than or equal to 100, 90, 80, 70, 60, 50, 45, 40, 35, 30, 25, 20, or 15 microns. In some embodiments, the first layer may have a thickness of greater than or equal to 10, 15, 20, 25, 30, 35, 40, 45, 50, 60, 70, or 80 microns. If the thickness of the first layer is too great, the stick pack may be too difficult for an adult to open without the use of a tool (e.g., scissors). If the thickness of the first layer is too small, the stick pack may be too easily opened by a child, and fail the child-proof requirements.

In some embodiments, film 210 comprises a second layer. In some embodiments, the second layer can comprise a metal (e.g., aluminum). In some embodiments, the second layer may have a thickness of 1-100, 10-50, 20-40, or 20-30 microns. In some embodiments, the second layer may have a thickness of less than or equal to 100, 90, 80, 70, 60, 50, 45, 40, 35, 30, 25, 20, 15, 10, or 5 microns. In some embodiments, the second layer may have a thickness of greater than or equal to 1, 5, 10, 15, 20, 25, 30, 35, 40, 45, 50, 60, 70, or 80 microns. If the thickness of the second layer is too great, the stick pack may be too difficult for an adult to open without the use of a tool (e.g., scissors). If the thickness of the second layer is too small, the stick pack may be too easily opened by a child, and fail the child-proof requirements.

In some embodiments, film 210 comprises a third layer. In some embodiments, when film 210 is scored according to any of the laser-scoring designs described herein, the third layer is exposed to an exterior environment. The third layer may include a polymeric material. For example, the third layer may comprise polyethylene. In some embodiments, the third layer may have a thickness of 5-100, 5-50, 5-30, or 10-15 microns. In some embodiments, the third layer may have a thickness of less than or equal to 100, 90, 80, 70, 60, 50, 40, 30, 25, 20, 15, or 10 microns. In some embodiments, the third layer may have a thickness of greater than or equal to 5, 10, 15, 20, 25, 30, 40, 50, 60, 70, or 80 microns. If the thickness of the third layer is too great, the stick pack may be too difficult for an adult to open without the use of a tool (e.g., scissors). If the thickness of the third layer is too small, the stick pack may be too easily opened by a child, and fail the child-proof requirements.

In some embodiments, film 210 may comprise a fourth layer. In some embodiments, the fourth layer is exposed to an outside environment when film 210 is used to form a stick pack. Further, the fourth layer of film 210 may be damaged or weakened during the laser scoring process to form the laser score design on the stick pack, enabling a user to be able to open the stick pack with only the use of their hands. In some embodiments, the fourth layer comprises a polymer. For example, the fourth layer may comprise PET. In some embodiments, the thickness of the fourth layer (prior to laser scoring) may be 5-100, 10-50, or 15-25 microns. In some embodiments, the thickness of the fourth layer (prior to laser scoring) may be less than or equal to 100, 90, 80, 70, 60, 50, 40, 30, 35, 30, 25, 20, 15, or 10 microns. In some embodiments, the thickness of the fourth layer (prior to laser scoring) may be greater than or equal to 5, 10, 15, 20, 25, 30, 40, 50, 60, 70, or 80 microns. If the thickness of the fourth layer is too great, the stick pack may be too difficult for an adult to open without the use of a tool (e.g., scissors). If the thickness of the fourth layer is too small, the stick pack may be too easily opened by a child, and fail the child-proof requirements.

Note that during the laser-scoring process, not all layers of the film are scored. At a minimum, the first layer of film 210 that is in contact with the fill contents of the stick-pack remains intact and is not scored. Thus, this first layer (and any subsequent layers that are also not scored) provide protection to the fill contents from the external environment (e.g., contamination, exposure to moisture or oxygen, leak/spill, etc.)

In some embodiments, a laminate (multilayer) film used to form a stick pack according to embodiments described herein may have no oxygen permeability and/or no water vapor permeability. In some embodiments, the oxygen permeability of a laminate film used to form a stick pack according to embodiments described herein may be 0 cc/m²·day (as measured using ASTM D-3985). In some embodiments, the water vapor permeability of a laminate film used to form a stick pack according to embodiments described herein may be 0 gr/m²·day (ASTM F-1249).

Any of the above-described layers may be omitted from a film used in a stick pack according to embodiments described herein. For example, a stick pack may comprise the first, third, and fourth layers, the second, third, and fourth layers, or just the first and third layers, just as an example.

In some embodiments, a stick pack may be made of film 210 comprising the following layers:

| Layer | Material | Thickness (microns) |
|---|---|---|
| First | PE | 27.14 |
| Second | Aluminum | 25.48 |
| Third | PE | 12.19 |
| Fourth | PET | 19.94 |

FIG. 2B shows a top view of a microscopic image of a laser-scored film, according to some embodiments. The film of FIG. 2B is shown with score 212, formed using a laser-scoring process. The laser-scoring process used to form the scores of stick packs described herein is based on a high-frequency induced CO₂ slab technology (e.g., Constantia Topebal Scanner).

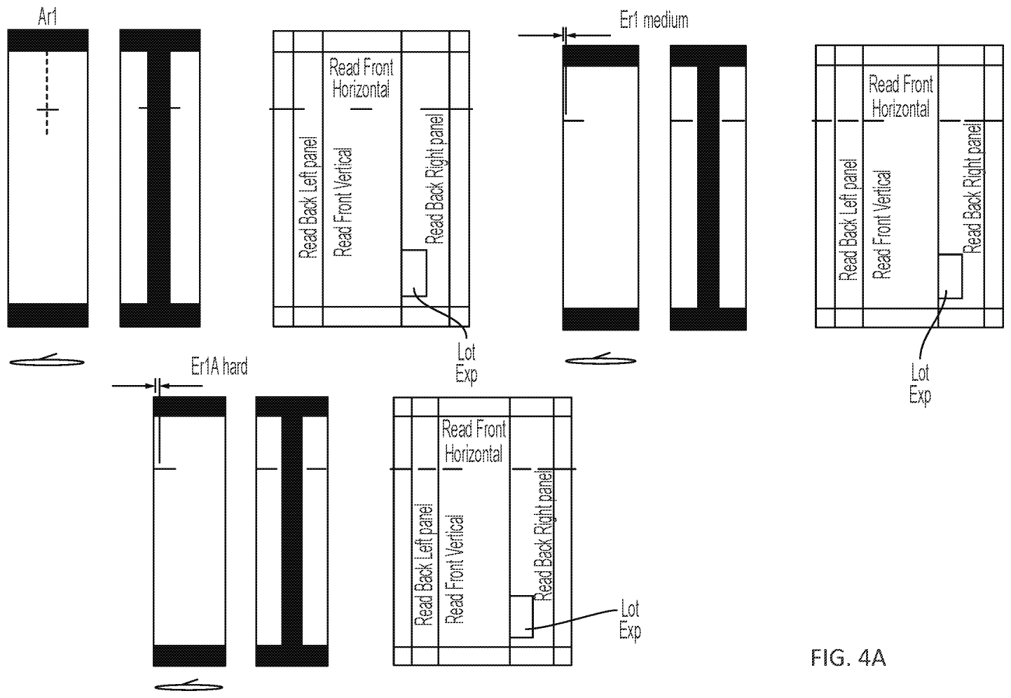

FIG. 3 shows various laser-scoring designs, according to some embodiments. As shown, the thick black areas show the film seals (i.e., a top seal, a bottom seal, and a rear seal). The horizontal lines/dashes located within a top half of each stick pack show the scoring pattern for each design. The black perforated line shown in some designs is a fold line. To tear open stick packs having a black perforated line, the user is instructed to fold the stick pack on the perforated line, and then tear along the scored design. In some embodiments, the scoring designs extend across an entire width of the stick pack. In some embodiments, the scoring designs are different between a front and a back of the stick pack. In some embodiments, the scoring pattern is focused at the fold line (i.e., black perforated line extending downwards from a top edge of the stick pack). Any one or more of the scoring designs provided in FIG. 3 may be appropriate for a stick pack that is child-proof or child-resistant.

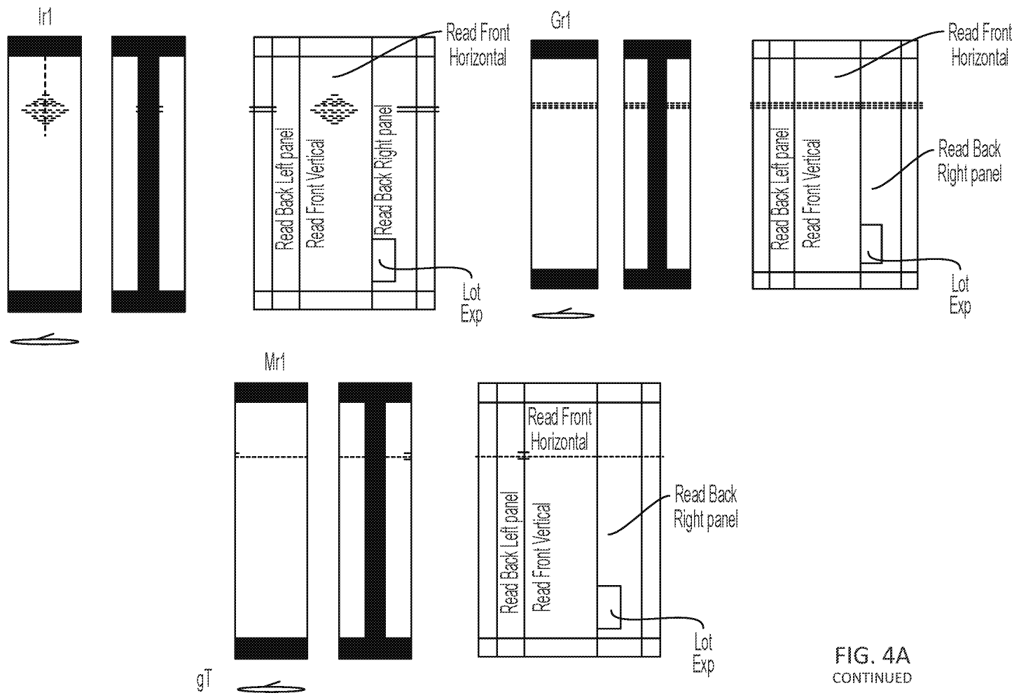

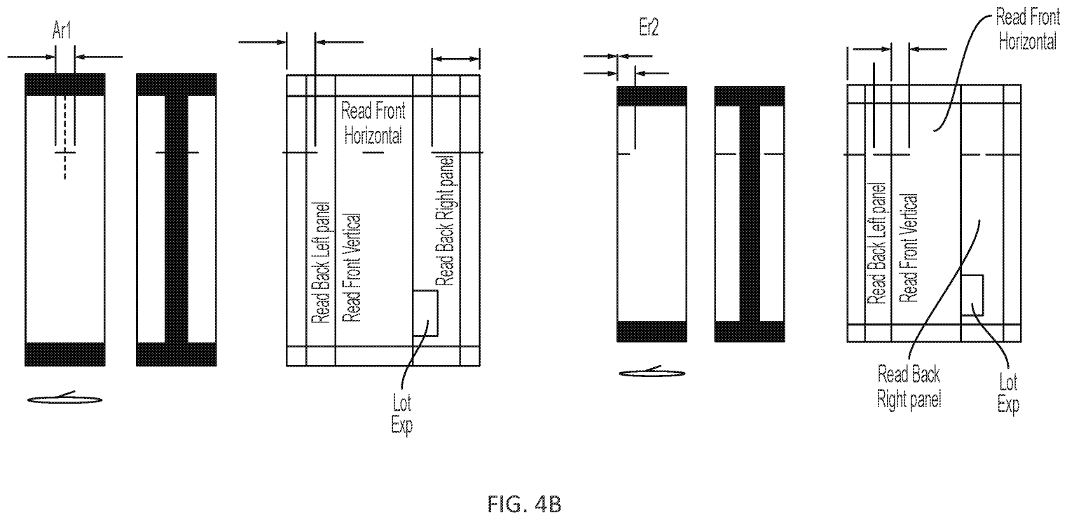

FIGS. 4A and 4B show various laser-scoring designs, according to some embodiments. Specifically, the embodiments provided in FIGS. 4A and 4B include a depiction of the scored flat film as well as a depiction of the final sealed stick pack. The black perforated line in some embodiments shows a fold line along which a user is instructed to fold when opening that particular stick pack design. The horizontal lines/dashes located on the top half of each of the stick packs show the scoring pattern for each stick pack design.

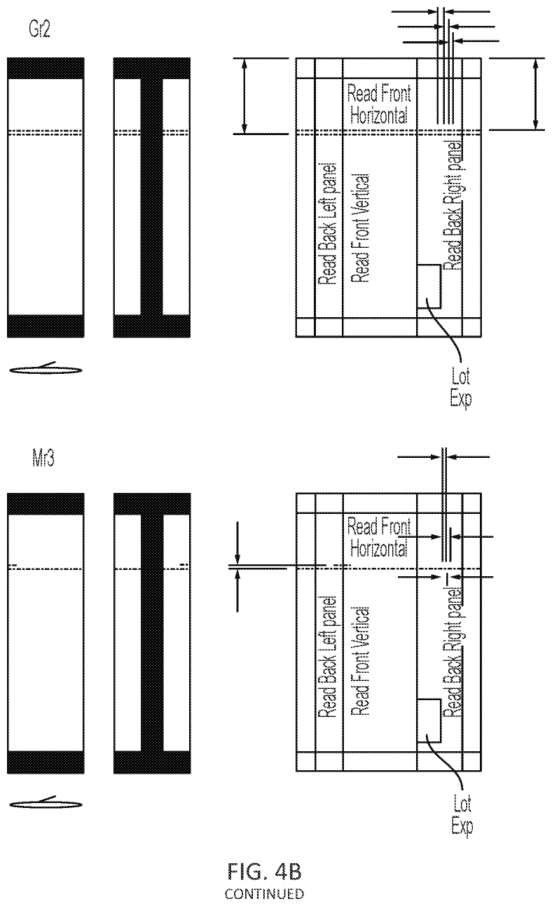

FIG. 5 shows two specific laser-scoring designs, Gr2 and Mr3, according to some embodiments. Specifically, FIG. 5 shows a front view of a stick pack having Gr2 scoring pattern and a front view of a stick pack having an Mr3 scoring pattern. As shown, the Gr2 stick pack design includes two perforated score lines that extend across the width of the assembled stick pack. However, the Mr3 scoring pattern includes only a single perforated score line that extends the width of the assembled stick pack. The Mr3 scoring pattern, however, includes scores above and below the perforated score line on at least one edge of the assembled stick pack. The size and the shape of the scores and the spacing between each score determine the ease at which a user (and a child) can open the stick pack using fingers and/or thumbs. The hash regions at the top and bottom of each stick pack image represent the upper and lower seals of the stick packs.

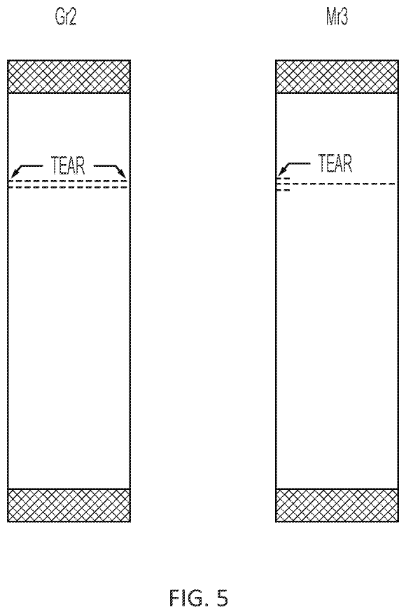

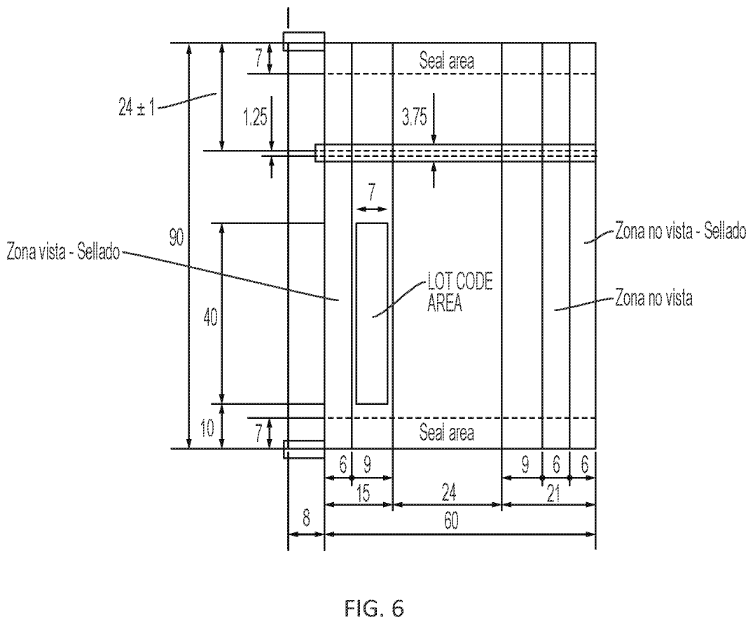

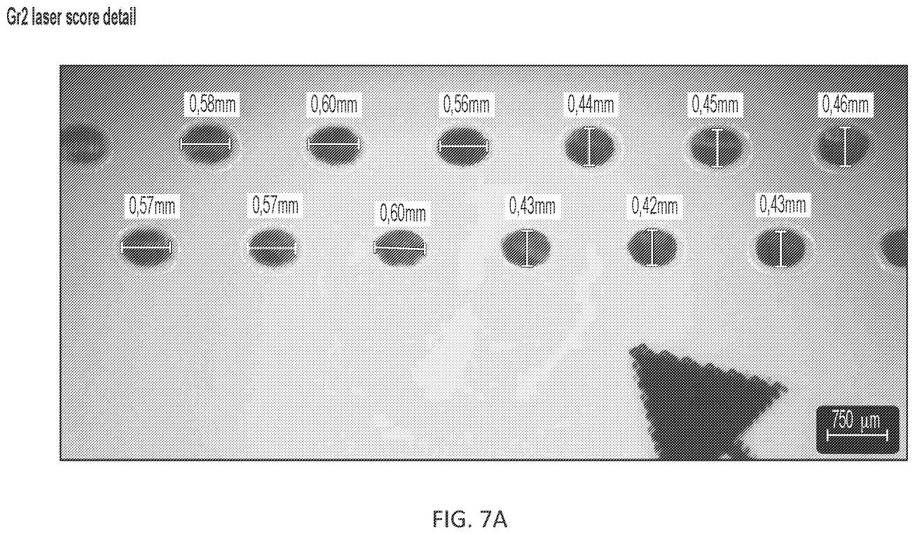

FIG. 6 shows a film design comprising the Gr2 laser-scoring design, according to some embodiments. Specifically, FIG. 6 shows a cut, laser-scored film just prior to being folded and sealed into a stick pack configuration. Exemplary dimensions of the film and resulting stick pack are provided on the Figure, although the dimensions of the film and stick pack can be easily adjusted based on consumer preference, fill content volume, etc. However, the dimensions of the scores (size, shape, and spacing between each score) directly impact the ease at which a user can open the stick pack. These dimensions are discussed in detail below, with respect to FIGS. 7A and 7B.

FIGS. 7A and 7B show a microscopic image of a Gr2 scoring design, according to some embodiments. As shown, the measurements of the scores generated by the laser have some slight variability. However, to ensure that a stick pack can be easily opened by an adult while at the same time resist being opened by a child, the dimensions of the scores according to a Gr2 scoring pattern should be within the limits described below.

In some embodiments, the width of each score of a Gr2 scoring pattern is 0.3-0.9, 0.4-0.8, or 0.5-0.7 mm. In some embodiments, the width of each score of a Gr2 scoring pattern is less than or equal to 0.9, 0.85, 0.8, 0.75, 0.7, 0.65, 0.6, 0.55, 0.5, 0.45, 0.4, or 0.35 mm. In some embodiments, the width of each score of a Gr2 scoring pattern is greater than or equal to 0.3, 0.35, 0.4, 0.45, 0.5, 0.55, 0.6, 0.65, 0.7, 0.75, 0.8, or 0.85 mm. If the width of the score is too large, it may be too easy to open (and possibly fail to be child-proof). If the width of the score is too small, it may be too difficult for an adult to open.

In some embodiments, the height of each score of a Gr2 scoring pattern is 0.1-0.8, 0.25-0.65, or 0.4-0.5 mm. In some embodiments, the height of each score of a Gr2 scoring pattern is less than or equal to 0.8, 0.75, 0.7, 0.65, 0.6, 0.55, 0.5, 0.45, 0.4, 0.35, 0.3, 0.25, 0.2, or 0.15 mm. In some embodiments, the height of each score of a Gr2 scoring pattern is greater than or equal to 0.1, 0.15, 0.2, 0.25, 0.3, 0.35, 0.4, 0.45, 0.5, 0.55, 0.6, 0.65, 0.7, or 0.75 mm. If the height of the score is too large, it may be too easy to open (and possibly fail to be child-proof). If the height of the score is too small, it may be too difficult for an adult to open.

In some embodiments, the horizontal distance between two side-by-side scores of a Gr2 scoring pattern is 0.5-1.5 or 0.8-1 mm. In some embodiments, the horizontal distance between two side-by-side scores is less than or equal to 1.5, 1.4, 1.3, 1.2, 1.1, 1, 0.9, 0.8, 0.7, or 0.6 mm. In some embodiments, the horizontal distance between two side-by-side scores is greater than or equal to 0.5, 0.6, 0.7, 0.8, 0.9, 1, 1.1, 1.2, 1.3, or 1.4 mm. If the horizontal distance between two scores is too large, it may make it too difficult for an adult to open the stick pack. If the horizontal distance between two scores is too small, it may be too easy to open (and possibly fail to be child-proof). Note that these horizontal distances are measured between two adjacent scores, and not from the center of one score to the center of an adjacent score.

In some embodiments, the Gr2 scoring pattern includes two rows of scores (as shown in the figures). In some embodiments, the scores of the top row are stacked directly on top of, and align vertically with, the scores of the bottom row. In some embodiments, the scores of the top row are staggered relative to the scores of the bottom row, such that a vertical line running through the middle of a score on the bottom row perpendicularly intersects a horizontal line running through the middle of each score of the top row at a location equidistant between two scores of the top row.

In some embodiments, the vertical distance between a score on a bottom row and a horizontal line running along the bottom edge of each score in the top row is 0.3-1.5 or 0.5-1 mm. In some embodiments, the vertical distance between a score on a bottom row and a horizontal line running along the bottom edge of each score in the top row is less than or equal to 1.5, 1.4, 1.3, 1.2, 1.1, 1, 0.9, 0.8, 0.7, 0.6, 0.5, or 0.4 mm. In some embodiments, a vertical distance between a score on the bottom row and a horizontal line running along the bottom edge of each score in the top row is greater than or equal to 0.3, 0.4, 0.5, 0.6, 0.7, 0.8, 0.9, 1, 1.1, 1.2, 1.3, or 1.4 mm. If the vertical distance is too large, it may make it too difficult for an adult to open the stick pack. If the vertical distance is too small, it may be too easy to open (and possibly fail to be child-proof). Note that these vertical distances are measured between scores, and not from the center of one score to the center of another score (or to a location along a horizontal line that runs through the center of another score).

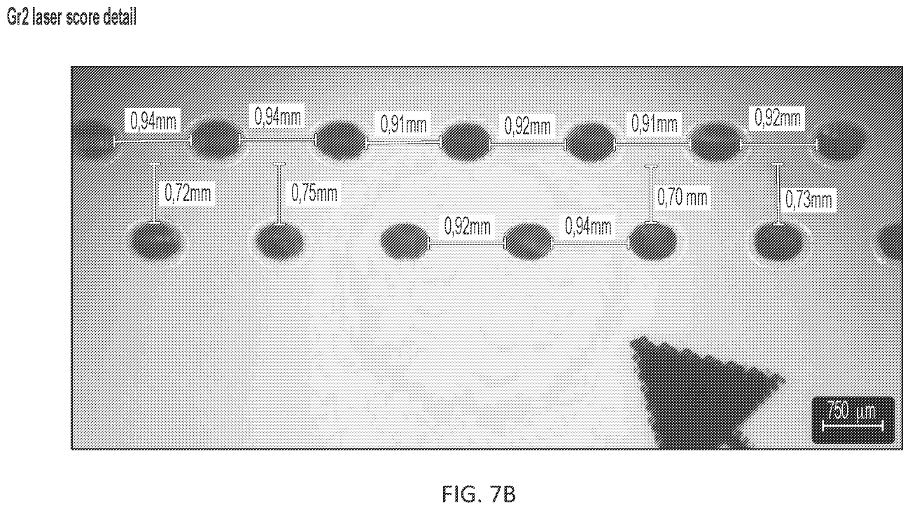

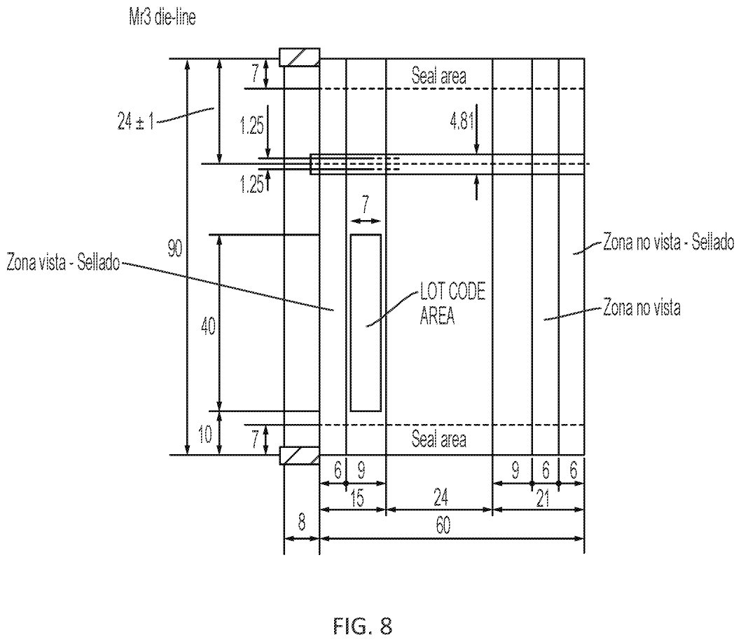

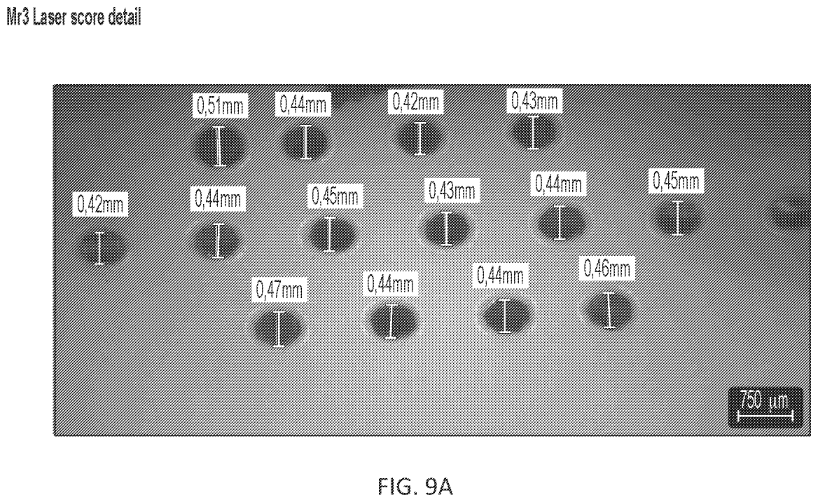

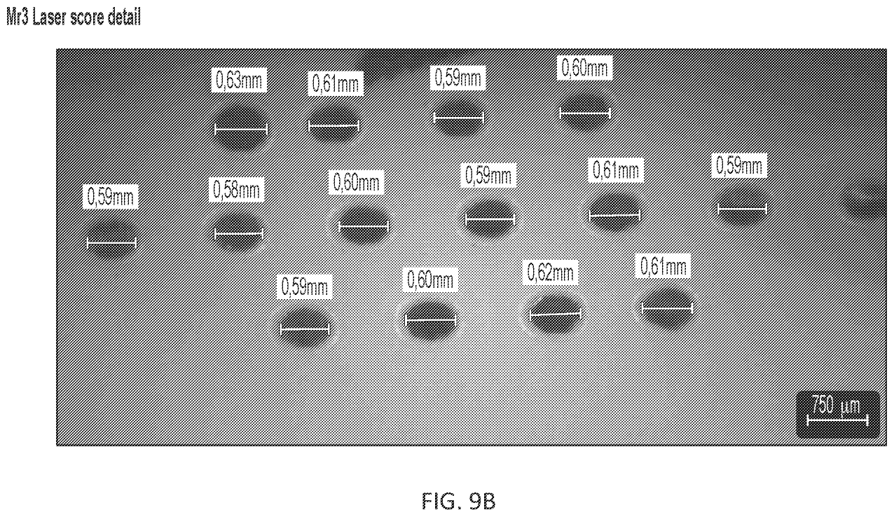

FIG. 8 shows a film design comprising the Mr3 laser-scoring design, according to some embodiments. Specifically, FIG. 8 shows a cut, laser-scored film just prior to being folded and sealed into a stick pack configuration. Exemplary dimensions of the film and resulting stick pack are provided on the Figure, although the dimensions of the film and stick pack can be easily adjusted based on consumer preference, fill content volume, etc. However, the dimensions of the scores (size, shape, and spacing between each score) directly impact the ease at which a user can open the stick pack. These dimensions are discussed in detail below, with respect to FIGS. 9A-9C.

FIGS. 9A-9C show microscopic images of an Mr3 scoring design, according to some embodiments. As shown, the Mr3 scoring design includes three rows stacked on top of each other. In some embodiments, the scores of one or more of the three rows are not vertically aligned with the scores of a different row. In some embodiments, no scores of any of the three rows are vertically aligned. Further, the measurements of the scores generated by the laser have some slight variability. However, to ensure that a stick pack can be easily opened by an adult while at the same time resist being opened by a child, the dimensions of the scores according to a Mr3 scoring pattern should be within the limits described below.

In some embodiments, the height of each score of an Mr3 design may be 0.1-1.5, 0.2-1, or 0.3-0.5 mm, as shown in FIG. 9A. In some embodiments, the height of each score of an Mr3 design may be less than or equal to 1.5, 1.4, 1.3, 1.2, 1.1, 1, 0.9, 0.8, 0.7, 0.6, 0.5, 0.4, 0.3, or 0.2 mm. In some embodiments, the height of each score of an Mr3 design may be greater than or equal to 0.1, 0.2, 0.3, 0.4, 0.5, 0.6, 0.7, 0.8, 0.9, 1, 1.1, 1.2, 1.3, or 1.4 mm. If the height of the scores of an Mr3 design are too large, it may be too easy to open (and possibly fail to be child-proof). Conversely, if the height of the scores of an Mr3 design are too small, it may make it too difficult for an adult to open the stick pack.

In some embodiments, the width of each score of an Mr3 design may be 0.1-1.5, 0.3-0.9, or 0.5-0.7 mm, as shown in FIG. 9B. In some embodiments, the width of each score of an Mr3 design may be less than or equal to 1.5, 1.4, 1.3, 1.2, 1.1, 1, 0.9, 0.8, 0.7, 0.6, 0.5, 0.4, 0.3, or 0.2 mm. In some embodiments, the width of each score of an Mr3 design may be greater than or equal to 0.1, 0.2, 0.3, 0.4, 0.5, 0.6, 0.7, 0.8, 0.9. 1, 1.1, 1.2, 1.3, or 1.4 mm. If the width of the scores of an Mr3 design are too large, it may be too easy to open (and possibly fail to be child-proof). Conversely, if the width of the scores of an Mr3 design are too small, it may make it too difficult for an adult to open the stick pack.

In some embodiments, the horizontal distance between two consecutive scores in a single row may be 0.1-2, 0.3-1.5, or 0.5-1 mm, as shown in FIG. 9C. In some embodiments, the horizontal distance between two consecutive scores in a single row is less than or equal to 1.5, 1.4, 1.3, 1.2, 1.1, 1, 0.9, 0.8, 0.7, 0.6, 0.5, 0.4, 0.3, or 0.2 mm. In some embodiments, the horizontal distance between two consecutive scores in a single row is greater than or equal to 0.1, 0.2, 0.3, 0.4, 0.5, 0.6, 0.7, 0.8, 0.9, 1, 1.1, 1.2, 1.3, or 1.4 mm. If the horizontal distance is too large, it may make it too difficult for an adult to open the stick pack. If the horizontal distance is too small, it may be too easy to open (and possibly fail to be child-proof). Note that these horizontal distances are measured between scores, and not from the center of one score to the center of another score.

In some embodiments, the vertical distance between two rows of scores (as measured from the top of one score of the middle row to the bottom of a score of the top row or to a horizontal line passing along the bottom of each score of the top row, or as measured from the top of one score of the bottom row to the bottom of a score of the middle row or to a horizontal line passing along the bottom of each score of the middle row) may be 0.1-2, 0.3-1.5, or 0.5-1 mm, as shown in FIG. 9C. In some embodiments, the vertical distance between two rows of scores of an Mr3 design may be less than or equal to 1.5, 1.4, 1.3, 1.2, 1.1, 1, 0.9, 0.8, 0.7, 0.6, 0.5, 0.4, 0.3, or 0.2 mm. In some embodiments, the vertical distance between two rows of scores of an Mr3 design may be greater than 0.1, 0.2, 0.3, 0.4, 0.5, 0.6, 0.7, 0.8, 0.9, 1, 1.1, 1.2, 1.3, or 1.4 mm. If the vertical distance is too large, it may make it too difficult for an adult to open the stick pack. If the vertical distance is too small, it may be too easy to open (and possibly fail to be child-proof).

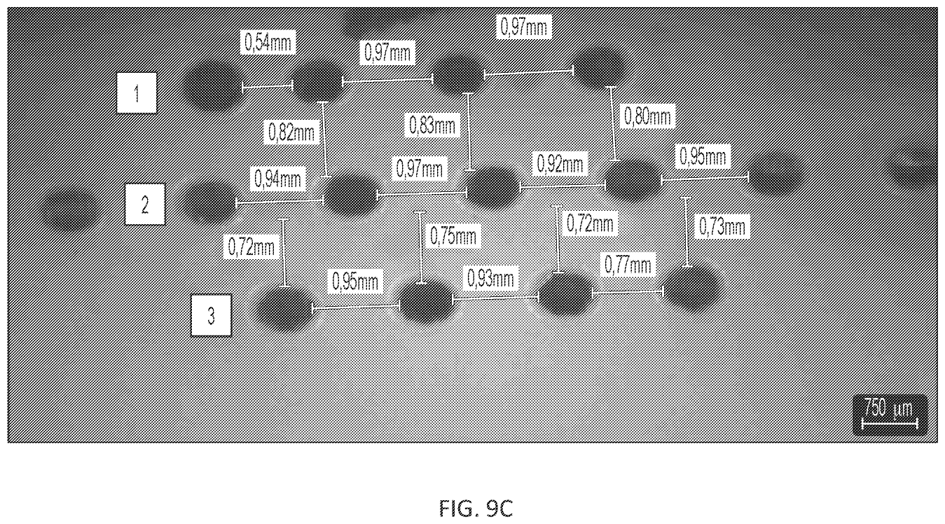

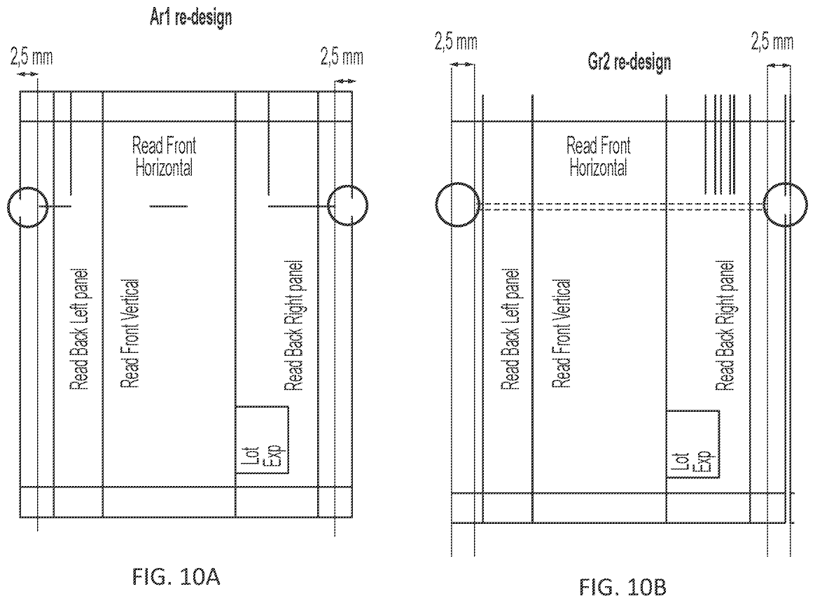

FIGS. 10A and 10B show film designs comprising a laser-scoring design that does not score the edge of the film, according to some embodiments. A laser scoring design that does not score the edge of the film may provide more protection against child tampering, therefore increasing the child resistance of the stick pack formed from the film. Specifically, the circles show where the laser scoring design stops short of scoring the edge of the film. The two laser scoring patterns shown are closely related to the Ar1 and Gr2 designs (depicted in FIGS. 4A and 4B, respectively,) except that the scores of the designs in FIG. 10A stop short of the edge of the film. This feature can affect the ease of which an adult and/or child can open the stick pack.

In some embodiments, the horizontal distance between the edge of a score and the edge of the film is 0.5-10, 1-5, or 2-3 mm. In some embodiments, the horizontal distance between the edge of a score and the edge of the film is less than or equal to 10, 9, 8, 7, 6, 5, 4, 3, 2, or 1 mm. In some embodiments, the horizontal distance between the edge of a score and the edge of the film is greater than or equal to 0.5, 1, 2, 3, 4, 5, 6, 7, 8, or 9 mm. If the distance between the edge of the film and the edge of the closest score is too large, then it may make it too difficult for an adult to open with just their hands/fingers. If the distance between the edge of the film and the edge of the closest score is too small, then it may make it too easy for a child to open (and thus, fail the child-proof requirement).

### EXAMPLES

To determine whether a particular laser scoring pattern is suitable (i.e., can be easily opened by an adult without the use of a tool, but cannot be opened easily by a child), stick packs comprising the various laser-scored patterns were tested both to determine how easily they could be opened by a child as well as how easily they could be opened by an adult.

Example 1: As shown in the table below, four different laser-scoring patterns (Ar1, Er2, Gr2, and Mr3) were tested using two different films (19F315 and 19A692) for ease of opening with both children and adults. Twenty-four children were tested, and fifty adults were tested. As shown, the scoring patterns of Ar1 and Er2 were too aggressive, since approximately half of the children were able to open the stick packs having these scoring patterns (with both films). However, the Gr2 and Mr3 scoring patterns performed well with both the child resistance testing and the adult testing.

| | | | con- | Children | | Adult | |
|---|---|---|---|---|---|---|---|
| | laser | | sumer | fail- | | fail- | # |
| Variable | score | film | test | ure/ | | ure/ | use |
| # | variable | material | codes | tested | trending | tested | tool |
| 1 | Ar1 | 19F315 | 691 | 11/24 | fail | 0/50 | 3 |
| 2 | | 19A692 | 465 | 13/24 | fail | 0/50 | 4 |
| 3 | Er2 | 19F315 | 872 | 13/24 | fail | 0/50 | 7 |
| 4 | | 19A692 | 934 | 11/24 | fail | 0/50 | 0 |
| 5 | Gr2 | 19F315 | 527 | 1/24 | pass | 0/50 | 19 |
| 6 | | 19A692 | 603 | 1/24 | pass | 0/50 | 4 |
| 7 | Mr3 | 19F315 | 778 | 0/24 | pass | 0/50 | 1 |
| 8 | | 19A692 | 540 | 0/24 | pass | 0/50 | 1 |

F=1
24 kids tested
50 adults

The child-resistance was tested as follows: Each child (of 24 total child, aged 45-51 months) was given one (1) Stick-Pack for the protocol testing. All packages contained placebo powder that simulated that actual product. An opening is defined as any breech of the Stick-Pack resulting in product (placebo) exposure. The total number of children who were able to gain access to at least one stick-pack was recorded.

The Stick-Pack was tested for an F=1 substance value. Accessing one unit equals a child opening failure. The Consumer Product Safety Commission requires a child-resistant effectiveness of no less than 90.00% percent with 50 children tested.

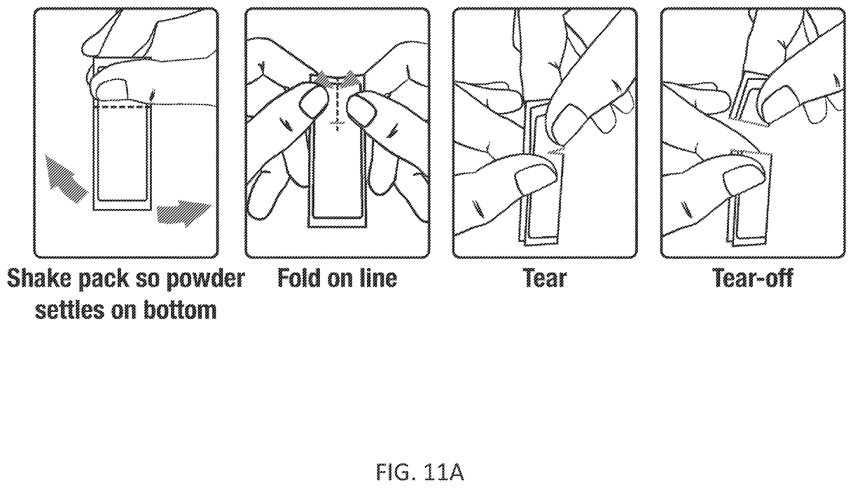

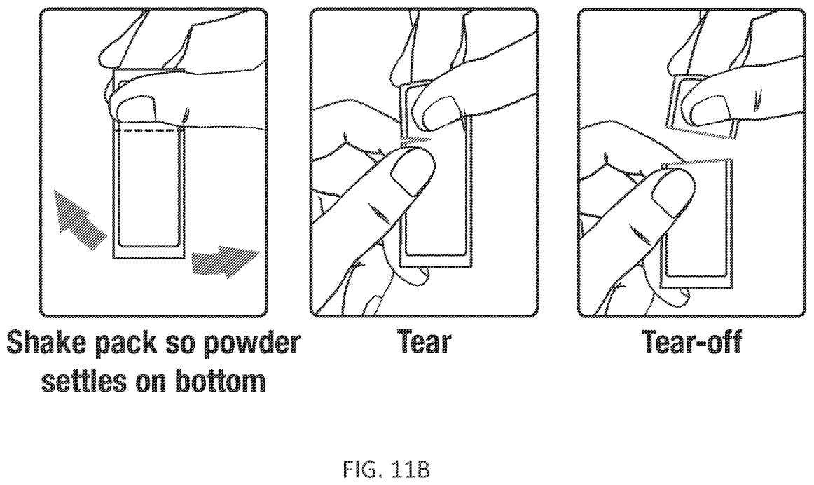

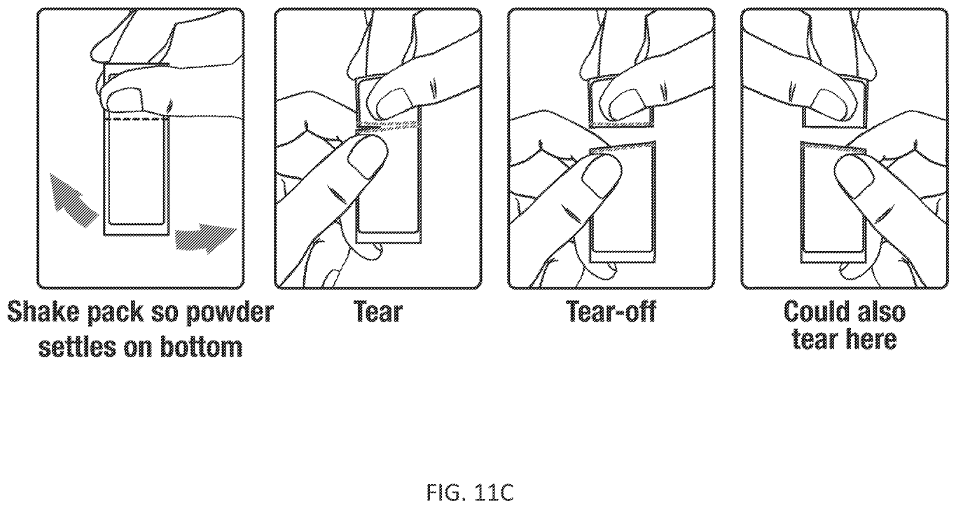

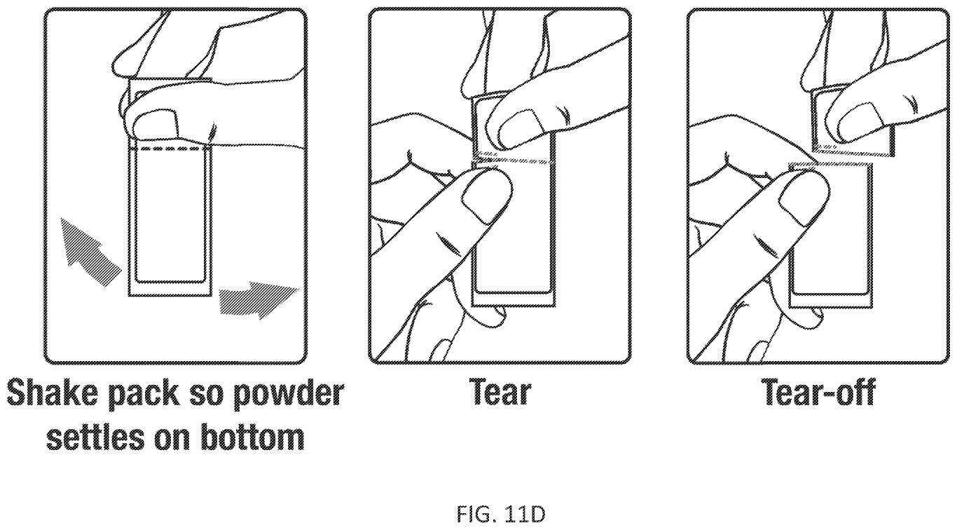

To test the ease of opening across a number of adults, each adult was provided a stick-pack according to each of the variables tested (as shown in the table). FIGS. 11A-11D provide visual instructions for opening stick packs having various laser-scored designs that were provided to each adult for each specific laser-scored design. Specifically, FIG. 11A shows instructions for opening a stick pack having an Ar1 laser-scored pattern, FIG. 11B shows instructions for opening a stick pack having an Er2 laser-scored pattern, FIG. 11C shows instructions for opening a stick pack having a Gr2 laser-scored pattern, and FIG. 11D shows instructions for opening a stick pack having an Mr3 laser-scored design.

Example 2: As shown in the table below, two different laser score patterns (Gr2 and Mr3) using two different films (19F315 and 19A692) were tested with adults across various criteria (i.e., Q1-Q12). These four stick packs (i.e., Gr2 with 19F315, Gr2 with 19A692, Mr3 with 19F315, and Mr3 with 19A692) were tested against various competitor products (stick packs labeled A, B, and C), as shown. The results show that overall, the Gr2 and Mr3 products (regardless of film material) are easier to open by adults than are the competitor products.

| | | 19F315 - 15 μm | | | | | | | |
|---|---|---|---|---|---|---|---|---|---|
| | | Alum | Gr2 | Gr2 | Mr3 | Mr3 | A | B | C |
| | Jumpstart Primary Package | 19A692 - 25 μm | 19F315 | 19A692 | 19F315 | 19A692 | (comp) | (comp) | (comp) |
| | Internal Opening Evaluation | Alum | 5 | 6 | 7 | 8 | 9 | 10 | 11 |
| Q1 | Based on your experience | (9 extremely easy - | 7.3 | 6.5 | 5.7 | 6.8 | 1.1 | 2.9 | 4.9 |
| | opening the package, how | 1 extremely | | | | | | | |
| | would you rate the | difficult) | | | | | | | |
| | ease/difficulty of opening the | | | | | | | | |
| | package? | | | | | | | | |
| Q2 | Based on your experience | 9 extremely easy - | 8.0 | 7.8 | 7.6 | 7.7 | 4.3 | 5.3 | 6.1 |
| | opening the package, how | 1 extremely | | | | | | | |
| | appropriate is this package for | difficult) | | | | | | | |
| | headache powder? | | | | | | | | |
| Q3 | What was your opening result | (5 Full open - 1 | 4.8 | 4.8 | 4.8 | 4.9 | 1.3 | 2.5 | 4.1 |
| | based on your initial try? (full | not open at all) | | | | | | | |
| | opening means you were able | | | | | | | | |
| | to rip the entire top off)? | | | | | | | | |
| Q3b | Use scissors | (yes - no) | 10/12 | 10/12 | 7 No | 6 No, | 12 Yes | 8 Yes, | 7 No, |
| | | | NO | NO | 1 | 1 yes, | | 3 No, | 3 Yes, |
| | | | 2 no | 2 no | Yes | 5 No | | 1 No | 2 No |
| | | | response | response | 2 no | response | | response | response |
| | | | | | response | | | | |
| Q4 | How do you feel about the | (5 extremely | 2.6 | 2.8 | 3.1 | 3.3 | 4.1 | 4.0 | 3.0 |
| | opened edge of the package? | smooth - 1 | | | | | | | |
| | | extremely | | | | | | | |
| | | jagged) | | | | | | | |
| Q5 | Did you experience any | (yes - no) | 11/12 | 10/12 | 10 No, | 12 NO | 10 No, | 11/20 | 12 NO |
| | spilling of powder when you | | NO | NO | 1 Yes, | | 1 Yes, | NO | |
| | opened the package? | | | | 1 No | | 1 No | | |
| | | | | | response | | response | | |
| Q7 | Based on your pouring | 9 extremely easy - | 7.3 | 7.8 | 7.0 | 7.5 | 8.0 | 8.0 | 7.0 |
| | experience, do you think it | 1 extremely | | | | | | | |
| | would be easy or difficult to | difficult) | | | | | | | |
| | pour the contents on your | | | | | | | | |
| | tongue? | | | | | | | | |
| Q8 | At the time when you poured | (yes - no) | 9/12 | 10/12 | 10/12 | 10/12 | 10/12 | 8/12 | 11/12 |
| | the contents into the bowl, did | | Yes | Yes | Yes | Yes | Yes | Yes | Yes |
| | you pinch the edges of the | | | | | | | | |
| | package to make it easier to | | | | | | | | |
| | pour the powder? | | | | | | | | |
| Q10 | How intuitive is it to open the | (9 extremely | 8.4 | 8.2 | 8.3 | 8.3 | 6.8 | 5.2 | 7.7 |
| | package? | intuitive - 1 | | | | | | | |
| | | extremely not | | | | | | | |
| | | intuitive) | | | | | | | |
| Q11 | What is your opinion of the | (9 extremely easy | 8.5 | 8.4 | 8.4 | 8.4 | 6.4 | 5.4 | 7.7 |
| | opening instructions? | to follow - 1 | | | | | | | |
| | | extremely | | | | | | | |
| | | difficult to | | | | | | | |
| | | follow) | | | | | | | |
| 012 | Which instruction did you pay | (3 word doc, 2 | 2.4 | 2.3 | 2.3 | 2.3 | 2.4 | 2.2 | 2.4 |
| | more attention to? | on-pack, 1 pay | | | | | | | |
| | | no attention) | | | | | | | |

Example 3: Below is an example fill formulation that may be used in combination with a child-proof stick pack described herein. As described above, the child-proof stick packs provided are designed to contain or package a therapeutic agent, supplement, and/or an active pharmaceutical ingredient. The formulation provided below includes aspirin, or acetylsalicylic acid, and caffeine as the therapeutic agent(s), supplement(s), and/or an active pharmaceutical ingredient(s).

| | | Quantity | Quantity | Ingredient |
|---|---|---|---|---|
| Material Name | Quantity | Unit | by % w/w | Function |
| Aspirin | 325.000 | mg | 29.122 | Drug Substance |
| Aspirin | 325.000 | mg | 29.122 | Drug Substance |
| Caffeine | 65.000 | mg | 5.824 | Drug Substance |
| Mannitol USP/EP | 310.000 | mg | 27.778 | Filler |
| Neotame | 1.000 | mg | 0.090 | Sweetener |
| Sucralose | 8.000 | mg | 0.717 | Sweetener |
| Natural Bitterness | 20.000 | mg | 1.792 | Flavoring |
| Masking Flavor | | | | Agents |
| Cooling Flavor, | 5.000 | mg | 0.448 | Flavoring |
| N&A | | | | Agents |
| Anhydrous Citric | 20.000 | mg | 1.792 | Buffering |
| Acid | | | | Agents |
| Sodium Citrate | 25.000 | mg | 2.240 | Buffering |
| Monobasic | | | | Agents |
| Evoglass Natural | 12.000 | mg | 1.075 | Flavoring |
| Flavor Raspberry | | | | Agents |
| Type | | | | |
| Total | 1116.000 | mg | 100.00 | |

### Example 4: Stability Study

Below is data showing the stability of an acetylsalicylic acid (ASA) and caffeine blend (0.65 g ASA and 65 mg caffeine) in a stick pack according to embodiments herein. Specifically, the laminate film used to form the stick pack included the following layers in the following order:

| Material | Thickness/Weight | |
|---|---|---|
| Polyethylene Terepthalate | 23 | μm |
| Polyethylene | 12 | gsm |
| Aluminum | 25 | μm |
| EXTR.COPOLYM | 25 | gsm |

The below table includes various data of the ASA/caffeine blend initially and at 3 months, 6 months, and 9 months as compared to the accepted criteria. As shown, all the results from initial to 9 months meet the criteria required in the corresponding specifications.

| | Release | Shelf Life | | | | |
|---|---|---|---|---|---|---|
| | Acceptance | Acceptance | | | | |
| Tests | Criteria | Criteria | Initial | 3 M | 6 M | 9 M |
| Appearance | White to off- | White to | White | White | White | White |
| | white powder | off-white | powder** | powder** | powder** | powder** |
| | | powder | | | | |
| Content Uniformity | | | | | | |
| (AV) | | | | | | |
| Aspirin | ≤15.0 | Not | 5.3 | Not | Not | Not |
| | | Required | | Required | Required | Required |
| Caffeine | ≤15.0 | Not | 9.3 | Not | Not | Not |
| | | Required | | Required | Required | Required |
| Identification by HPLC | | | | | | |
| by RT | | | | | | |
| Aspirin | The retention | Not | Conformed | Not | Not | Not |
| | time of the | Required | | Required | Required | Required |
| Caffeine | major peak in | Not | Conformed | | | |
| | the sample | Required | | | | |
| | chromatograms | | | | | |
| | and the | | | | | |
| | retention times | | | | | |
| | of the API | | | | | |
| | peak in the | | | | | |
| | standard | | | | | |
| | chromatograms | | | | | |
| | do not differ | | | | | |
| | by more | | | | | |
| | than ±5%. | | | | | |
| Identification by HPLC | | | | | | |
| by UV | | | | | | |
| Aspirin | The UV | Not | Conformed | Not | Not | Not |
| | spectra of the | Required | | Required | Required | Required |
| Caffeine | major peak in | Not | Conformed | | | |
| | the sample | Required | | | | |
| | chromatograms | | | | | |
| | closely match | | | | | |
| | the UV spectra | | | | | |
| | of the API | | | | | |
| | peak in the | | | | | |
| | standard | | | | | |
| | chromatograms | | | | | |
| | between 210 | | | | | |
| | nm-360 nm. | | | | | |
| Assay (% LC) | | | | | | |
| Aspirin | 95.0%-105.0% | 90.0%-110.0% | 95.6 | 97.5 | 94.6 | 97.0 |
| Caffeine | 95.0%-105.0% | 90.0%-110.0% | 99.8 | 99.5 | 95.6 | 100.4 |
| Impurities/Degradation | | | | | | |
| Products | | | | | | |
| Aspirin Related | Aspirin Related (% LC) | | | | | |
| FSA (% LC) | ≤1.0% | ≤3.0% | 0.1 | 0.1 | 0.1 | 0.1 |
| ASSA (% LC) | ≤0.2% | ≤1.0% | <LOQ | 0.0 | 0.0 | 0.0 |
| Any ASA Related | Aspirin Related (% LC) | | | | | |
| (% LC) | | | | | | |
| RRT 0.92 | ≤0.10% | ≤0.2% | <LOQ | ND | <LOQ | ND |
| RRT 1.21 | | | <LOQ | <LOQ | <LOQ | <LOQ |
| Total ASA Related | ≤1.5% | ≤5.0% | 0.1 | 0.1 | 0.1 | 0.1 |
| (% LC) | | | | | | |
| Caffeine Related | Caffeine Related (% LC) | | | | | |
| Paraxanthine (% LC) | ≤0.1% | ≤0.2% | <LOQ | ND | ND | ND |
| Any Caff Related (% LC) | ≤0.1% | ≤0.2% | ND | ND | ND | ND |
| Total Caff Related | ≤0.2% | ≤1.0% | ND | ND | ND | ND |
| (% LC) | | | | | | |
| Unspecified | Unspecified (% LC) | | | | | |
| Single Unspecified | ≤0.2% | ≤0.2% | ND | ND | ND | ND |
| (% LC) | | | | | | |
| Total Unspecified | ≤0.5% | ≤1.0% | ND | ND | ND | ND |
| (% LC) | | | | | | |
| Loss on Drying | Report Results | Report | S1 = 0.27 | S1 = 0.30 | S1 = 0.30 | S1 = 0.30 |
| (% w/w) | | Results | S2 = 0.25 | S2 = 0.30 | S2 = 0.30 | S2 = 0.32 |
| | | | Mean = 0.26 | Mean = 0.30 | Mean = 0.30 | Mean = 0.31 |

Legend:
ND means “Not Detected”
LOQ represents “Limit of Quantitation” (0.05%)
**Observation: A puffing package instead of been flat package observed for all samples

The below table includes various data of the ASA/caffeine blend initially and at 1 month, 2 months, 3 months, and 6 months as compared to the accepted criteria. As shown, all the results from initial to 6 months meet the criteria required in the corresponding specifications.

| | Release | Shelf Life | | | | | |
|---|---|---|---|---|---|---|---|
| | Acceptance | Acceptance | | | | | |
| Tests | Criteria | Criteria | Initial | 1 M | 2 M | 3 M | 6 M |
| Appearance | White to off- | White to off- | White | White | White | White | White |
| | white powder | white powder | powder** | powder** | powder** | powder** | powder** |
| Assay (% LC) | | | | | | | |
| Aspirin | 95.0%-105.0% | 90.0%-110.0% | 95.6 | 99.4 | 98.2 | 97.4 | 95.6 |
| Caffeine | 95.0%-105.0% | 90.0%-110.0% | 99.8 | 103.7 | 101.2 | 100.6 | 100.0 |
| Impurities/ | | | | | | | |
| Degradation | | | | | | | |
| Products | | | | | | | |
| Aspirin | Aspirin Related (% LC) | | | | | | |
| Related | | | | | | | |
| FSA(% LC) | ≤1.0% | ≤3.0% | 0.1 | 0.1 | 0.3 | 0.2 | 0.5 |
| ASSA(% LC) | ≤0.2% | ≤1.0% | <LOQ | <LOQ | <LOQ | 0.0 | 0.0 |
| Any ASA | ≤0.10% | ≤0.2% | | | | | |
| Related | | | | | | | |
| (% LC) | | | | | | | |
| RRT 0.92 | | | <LOQ | ND | ND | ND | <LOQ |
| RRT 1.05 | | | <LOQ | <LOQ | <LOQ | <LOQ | <LOQ |
| RRT 1.21 | | | ND | ND | ND | <LOQ | ND |
| RRT 2.20 | | | ND | ND | <LOQ | ND | ND |
| Total ASA | ≤1.5% | ≤5.0% | 0.1 | 0.2 | 0.3 | 0.3 | 0.5 |
| Related | | | | | | | |
| (% LC) | | | | | | | |
| Caffeine | Caffeine Related (% LC) | | | | | | |
| Related | | | | | | | |
| Paraxanthine | ≤0.1% | ≤0.2% | <LOQ | ND | ND | ND | ND |
| (% LC) | | | | | | | |
| Any Caff | ≤0.1% | ≤0.2% | ND | ND | ND | ND | ND |
| Related | | | | | | | |
| (% LC) | | | | | | | |
| Total Caff | ≤0.2% | ≤1.0% | ND | ND | ND | ND | ND |
| Related | | | | | | | |
| (% LC) | | | | | | | |
| Unspecified | Unspecified (% LC) | | | | | | |
| Single | ≤0.2% | ≤0.2% | ND | ND | ND | ND | ND |
| Unspecified | | | | | | | |
| (% LC) | | | | | | | |
| Total | ≤0.5% | ≤1.0% | ND | ND | ND | ND | ND |
| Unspecified | | | | | | | |
| (% LC) | | | | | | | |
| Loss on | Report | Report | S1 = 0.27 | S1 = 0.27 | S1 = 0.22 | S1 = 0.25 | S1 = 0.30 |
| Drying (% | Results | Results | S2 = 0.25 | S2 = 0.32 | S2 = 0.25 | S2 = 0.27 | S2 = 0.27 |
| w/w) | | | Mean = 0.26 | Mean = 0.30 | Mean = 0.24 | Mean = 0.30 | Mean = 0.29 |

Legend:
ND means “Not Detected”
LOQ represents “Limit of Quantitation” (0.05%)
**Observation: A puffing package instead of been flat package observed for all samples

The foregoing description sets forth exemplary systems, methods, techniques, parameters, and the like. It should be recognized, however, that such description is not intended as a limitation on the scope of the present disclosure but is instead provided as a description of exemplary embodiments.

Although the description herein uses terms first, second, etc. to describe various elements, these elements should not be limited by the terms. These terms are only used to distinguish one element from another.

1. A child-proof stick pack comprising:
a single sheet of film comprising two or more layers, wherein at least one layer comprises polyethylene terephthalate and faces an environment exterior to the stick pack;
a laser-scored design on the film comprising a plurality of scores, wherein each score of the plurality of scores comprises an area in which the polyethylene terephthalate layer is weakened or removed from the film,
wherein the stick pack comprises a bottom seal, a top seal, and a rear seal extending between the top seal and the bottom seal, is configured to contain one or more of an active pharmaceutical ingredient, therapeutic agent, or supplement and cannot be opened by more than 20% of children under the age of 5 years using only two hands.

2. The child-proof stick pack of claim 1, wherein the stick pack cannot be opened by more than 10% to more than 15% of children under the age of 5 years using only two hands.

3. (canceled)

4. The child-proof stick pack of claim 1, wherein the plurality of scores extend horizontally across a width of the stick pack and perpendicular to the extending direction of the rear seal.

5. The child-proof stick pack of claim 1, wherein the plurality of scores are located closer to the top seal of the stick pack than the bottom seal.

6. The child-proof stick pack of claim 1, wherein the film comprises:
a first layer of polyethylene wherein the first layer of polyethylene is 20-40 microns thick.

7. The child-proof stick pack of claim 6, wherein the film comprises a layer of aluminum overlying the layer of polyethylene wherein the layer of aluminum is 20-30 microns thick.

8. The child-proof stick pack of claim 7, wherein the film comprises a second layer of polyethylene overlying the layer of aluminum wherein the second layer of polyethylene is 5-30 microns thick.

9. The child-proof stick pack of claim 8, wherein the layer of polyethylene terephthalate overlies the second layer of polyethylene wherein the layer of polyethylene terephthalate is 15-25 microns thick.

10. The child-proof stick pack of claim 1, wherein the laser-scored design comprises at least two rows of scores.

11. (canceled)

12. The child-proof stick pack of claim 1, wherein each score is 0.5-0.7 mm wide.

13. The child-proof stick pack of claim 1, wherein each score is 0.3-0.6 mm in height.

14. The child-proof stick pack of claim 10, wherein a vertical distance between any two rows of scores is 0.6-0.9 mm, as measure from a bottom edge of a score of a first row to a location horizontally aligned with a top edge of a score of a second row, wherein the second row is below the first row.

15. The child-proof stick pack of claim 1, wherein an edge of the single sheet of film is scored or is not scored.

16. (canceled)

17. The child-proof stick pack of claim 10, wherein the scores of a first row are vertically aligned or are not vertically aligned with at least one score the scores of a second row.

18-22. (canceled)

23. The child-proof stick pack of claim 1, wherein the one or more of an active pharmaceutical ingredient, therapeutic agent, or supplement comprises a non-steroidal anti-inflammatory drug.

24. The child-proof stick pack of claim 23, wherein the non-steroidal anti-inflammatory drug comprises one or more of naproxen sodium, acetylsalicylic acid, acetaminophen, or ibuprofen.

25. The child-proof stick pack of claim 1, wherein the one or more of an active pharmaceutical ingredient, therapeutic agent, or supplement comprises an antihistamine.

26. The child-proof stick pack of claim 25, wherein the antihistamine comprises one or more of loratadine, desloratadine, diphenylhydramine, pseudoephedrine sulfate, or phenylephrine hydrochloride.

27. The child-proof stick pack of claim 1, wherein the one or more of an active pharmaceutical ingredient, therapeutic agent, or supplement comprises one or more of omeprazole, esomeprazole magnesium, sodium bicarbonate, polyethylene glycol 3350, caffeine, multivitamins, teas, protein powder, orlistat, doconazole, nizatidine, levonorgestrel, sildenafil citrate, or vardenafil.

28. A child-proof stick pack comprising:
a single sheet of film comprising two or more layers, wherein at least one layer comprises polyethylene terephthalate and faces an environment exterior to the stick pack;
a laser-scored design on the film comprising a plurality of scores, wherein each score of the plurality of scores comprises an area in which the polyethylene terephthalate layer is weakened or removed from the film,
wherein the stick pack comprises a bottom seal, a top seal, and a rear seal extending between the top seal and the bottom seal, and cannot be opened by more than 20% of children under the age of 5 years using only two hands; and
wherein the child-proof stick pack encloses a fill formulation comprising one or more of aspirin or caffeine.
